(19) United States
(12) Patent Application Publication
(10) Pub. No.: US 2016/0357616 A1
(43) Pub. Date: Dec. 8, 2016

(54) APPLICATION MANAGEMENT METHOD AND APPLICATION MANAGEMENT APPARATUS

(71) Applicant: Beijing Zhigu Rui Tuo Tech Co., Ltd, Beijing (CN)

(72) Inventors: Kuifei YU, Beijing (CN); Hongjiang ZHANG, Beijing (CN); Wei SHI, Beijing (CN)

(21) Appl. No.: 14/778,475

(22) PCT Filed: Dec. 10, 2013
(86) PCT No.: PCT/CN2013/088925

§ 371 Date: Sep. 29, 2015

(30) Foreign Application Priority Data
Mar. 29, 2013 (CN) 201310109483.4

(51) Int. Cl. G06F 9/54; G06N 7/00

(52) U.S. Cl. CPC G06F 9/541; G06N 7/005

(57) ABSTRACT

Disclosed are an application management method and device, the method including: acquiring at least one piece of condition information, where at least one function of at least one application relies on the condition information; and judging whether a change occurs to a state of availability of a function of an application relying on the condition information according to the acquired condition information: if the change occurs, changing a state of the corresponding application according to the change. The device includes an acquisition module, a judgment module and an application state change module implementing the method. Resources consumed by an application are reduced as a condition on which a function of the application relies cannot satisfy normal use of the application, unnecessary user operations are reduced, and user experience is improved.

### RELATED APPLICATIONS

This application is a U.S. National Stage patent application filing under 35 USC §371 of, and claims priority to, international Patent Cooperation Treaty (PCT) Application No. PCT/CN2013/088925, filed on Dec. 10, 2013, and entitled “APPLICATION MANAGEMENT METHOD AND APPLICATION MANAGEMENT APPARATUS,” which claims priority to China Patent Application No. 201310109483.4, filed with the Chinese Patent Office on Mar. 29, 2013 and entitled “APPLICATION MANAGEMENT METHOD AND DEVICE”, which applications are hereby incorporated herein by reference in their respective entireties.

### TECHNICAL FIELD

The present application relates to the field of communications, and in particular, to application management.

### BACKGROUND

With development of technologies, a user can experience more and a wide variety of applications through a terminal, functions of many applications in the terminal can only be implemented based on a particular capability and/or context of a system, and when the particular capability and/or context of the system cannot meet the requirements, the functions of the applications may be in an unavailable state, and at this time:

1. The user does not know that the functions of the applications are in an unavailable state, finds that part of or all the functions of the applications are unavailable after clicking display icons corresponding to the applications to open the applications, and then exits the applications, which may consume power of the system and other system resources, and also have bad effects on user experience.

2. The applications constantly try to detect whether the particular capability and/or context of the system has met the condition in the background, and the trying process also may consume power of the system and other system resources. In addition, some applications are operating in the background all the time, the user may not use the applications in a set period of time, and thus the operation in the background also may consume power and other resources.

Especially for a mobile terminal, as capacity of a battery is limited, unnecessary consumption may shorten the service life of the device, and deteriorate the user experience.

### SUMMARY

A technical problem to be solved by one or more embodiments of the subject application is to provide an application management method and device, so as to reduce consumption of resources corresponding to applications and improve user experience.

In a first aspect, the subject application provides an application management method, including:

acquiring at least one piece of condition information, where at least one function of at least one application relies on the condition information; and

judging whether a change occurs to a state of availability of a function of an application relying on the condition information according to the acquired condition information:

if the change occurs, changing a state of the corresponding application according to the change.

In a second aspect, the subject application provides an application management device, including:

an acquisition module, for acquiring at least one piece of condition information, where at least one function of at least one application relies on the condition information;

a judgment module, for judging whether a change occurs to a state of availability of a function of an application relying on the condition information according to the condition information acquired by the acquisition module, and generating corresponding change information when the change occurs; and

an application state change module, for changing a state of the corresponding application according to the change information.

In a third aspect, the subject application provides a computer program product, where the computer program product makes a computer execute the method according to the subject application.

In a fourth aspect, the subject application provides a computer readable medium, where the computer readable medium includes a computer executable instruction, and when a central processing unit (CPU) of a computer executes the computer executable instruction, the computer executable instruction is used for making the computer execute the method according to the subject application.

In a fifth aspect, the subject application provides an application management device, where the application management device includes a processor, a memory and a communications interface; the memory stores a computer operating instruction, and the processor, the memory and the communications interface are connected through a communications bus; and when the application management device operates, the processor executes the computer operating instruction stored by the memory, so that the application management device executes the method according to the subject application.

A technical solution according to one or more embodiments of the subject application changes a state of an application in time when a condition on which a function of the application relies makes a state of availability of the function of the application change, which reduces resources consumed by the application as the condition on which the function of the application relies cannot satisfy normal use of the application, reduces unnecessary user operations, and improves user experience.

### BRIEF DESCRIPTION OF THE DRAWINGS

FIG. 1 is a schematic flow chart of an application management method according to an embodiment of the subject application;

FIG. 2a and FIG. 2b are schematic views of states of a display icon and a display list of an application management method after a state of an application changes according to an embodiment of the present subject application;

FIG. 3 is a schematic structural view of an application management device according to an embodiment of the subject application;

FIG. 4 is a schematic structural view of another application management device according to an embodiment of the subject application; and

FIG. 5 is a schematic structural view of a further application management device according to an embodiment of the subject application.

### DETAILED DESCRIPTION

An application management method and device of the subject application are described below in detail with reference to accompanying drawings and embodiments.

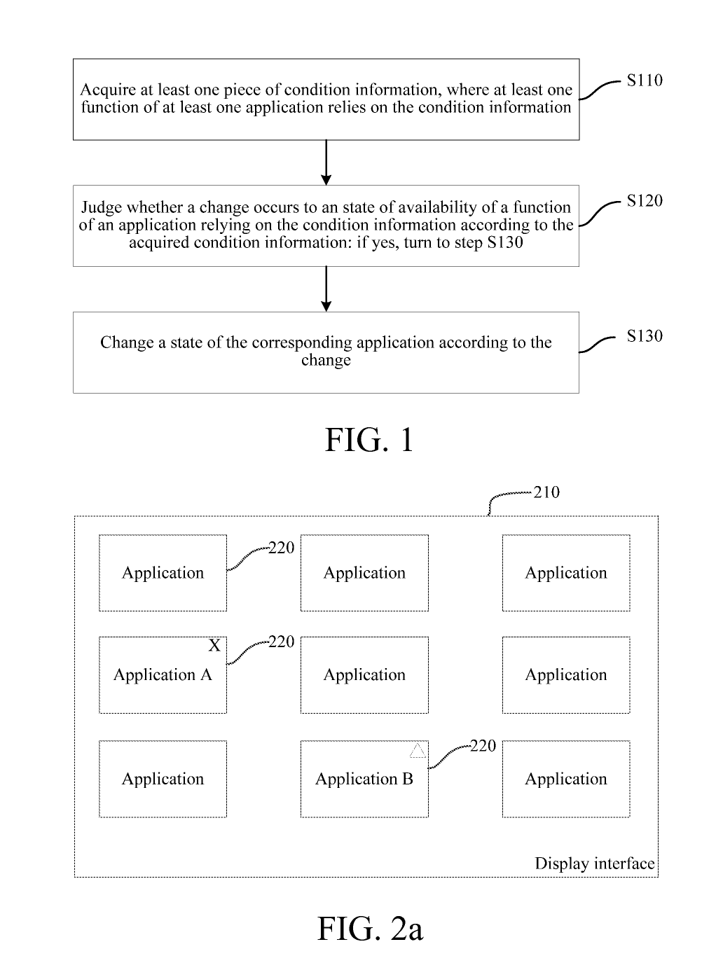

As shown in FIG. 1, an embodiment of the subject application provides an application management method, which includes the following steps.

S110: Acquire at least one piece of condition information, where at least one function of at least one application relies on the condition information.

Herein, there may be many manners of acquiring the condition information, for example, it can be obtained automatically inside a system, it can be obtained automatically through an external sensing device, a user may obtain it through input of an interactive device and the like.

The condition information acquired may be one or more, and one or more functions of one or more applications rely on each piece of condition information. Persons skilled in the art may know that, a function of an application also may rely on multiple pieces of condition information at the same time.

In a possible implementation manner of an embodiment of the subject application, the condition information includes context information relevant to a system where the application is located.

The context information relevant to a system where the application is located can include at least one of the following information: time, location, temperature, humidity, social environment, acceleration of the system and inclination of the system (herein, the “inclination of the system”, for example, may be an included angle between a system and a horizontal plane, and the inclination can serve as a parameter for judging a current use state of the system). For example, a function of a certain application relies on a signal state of the location, and when the acquired condition information is that the location of the system is inside a tunnel, the signal state of the location is not good, and the function of the application cannot be normally used. Certainly, persons skilled in the art may know that, other context information on which the function of the application relies also can be incorporated into the context information in an embodiment of the subject application, to serve as one of factors for next judgment.

In a possible implementation manner of an embodiment of the subject application, the condition information includes capability information relevant to a system where the application is located.

The capability information relevant to a system where the application is located can include at least one of the following information: positioning capability, data access capability, communication capability, direction indication capability, storage capability, operational capability, multimedia output capability, input capability and local data access capability. For example, a function of a certain application is downloading a video file with a larger amount of data, which relies on storage capability of the system, and when the acquired condition information is that storage capability of the system is reduced to a certain level and the file downloaded by the application cannot be maintained, the function of the application cannot be normally used. Certainly, persons skilled in the art may know that, other capability information on which the function of the application relies also can be incorporated into the capability information in an embodiment of the subject application, to serve as one of factors for next judgment.

In a possible implementation manner of an embodiment of the subject application, the condition information includes user usage mode information.

The user usage mode information can include at least one of the following information: probability that a user uses the application and probability that the user uses the application in the case that a system relevant to the application is in a particular context and/or capability. For example, probability that a user, in a particular context, i.e., at nine to eleven a.m., in the office, uses a game function of a certain application. Certainly, persons skilled in the art may know that, other user usage mode information on which the function of the application relies also can be incorporated into the user usage mode information in an embodiment of the subject application, to serve as one of consideration factors for next judgment.

In a possible implementation manner of an embodiment of the subject application, the condition information includes service plan information.

The service plan information can include at least one of the following information: service quota limit and currently used quota information, service time limit information and service geographical limit information. The service quota limit and currently used quota information, for example, may be: a purchased data packet and a currently used data traffic, a purchased voice call packet and currently used call duration, a purchased message service packet and the currently used number and the like; the service time limit information, for example, may be: expiration time information of a voucher on an online shopping account (e.g., an expiration reminder message sent by an online shopping website) and the like; and the service geographical limit information, for example, may be: e-coupons of a certain chain restaurant that only can be used in a certain city and the like. Certainly, persons skilled in the art may know that, other service plan information on which the function of the application relies also can be incorporated into the service plan information in an embodiment of the subject application, to serve as one of consideration factors for next judgment.

The acquired condition information in the embodiment of the subject application may be one piece of a certain type of condition information described above, for example, positioning capability in the capability information; may be more pieces of a certain type of condition information; or may be more pieces of multiple types of condition information, such as time in the context information, local data access capability in the capability information and the like.

S120: Judge whether a change occurs to a state of availability of a function of an application relying on the condition information according to the acquired condition information:

if the change occurs, turn to step S130.

Whether a change occurs to a state of availability of a function of an application relying on the condition information can be judged according to the condition information acquired in step S110, for example, as stated above, when the system is inside a tunnel and the signal state is not good, the state of availability of a function of an application relying on the signal state of the location is changed into an unavailable state, that is, a change occurs.

In a possible implementation manner of an embodiment of the subject application, parameter information of the application can include information about reliance of the application on the corresponding condition information. The step S120 further includes: judging whether a change occurs to a state of availability of a function of an application relying on the condition information according to the acquired condition information and the information about reliance of the application on the corresponding condition information. For example, functions of some applications rely on direction indication capability in the capability information, but reliance of functions of some applications on the direction indication capability is very strong, and the functions of the applications cannot be implemented when the direction indication capability of the system is not high enough; functions of some other applications rely on the direction indication capability, but reliance is not very strong, and the functions thereof can be implemented even if the direction indication capability of the system is weak; while functions of some applications completely do not rely on the direction indication capability. Reliance of the functions of the applications on the direction indication capability can be graded, for example, the reliance is divided into three levels herein, the first level is that reliance is very strong, the second level is that the reliance is general, and the third level is that the reliance does not exist at all. The condition information acquired in step S110 includes the direction indication capability of the system, and when the direction indication capability is general, for the applications with the reliance in the second level and the third level, the availability of the corresponding functions thereof does not change; while for the applications with the reliance in the first level, the availability of the corresponding functions thereof changes.

S130: Change a state of the corresponding application according to the change.

In a possible implementation manner of an embodiment of the subject application, the step of changing a state of the corresponding application is changing a state of availability of the corresponding application. The state of availability of the application includes: a state where the application is available and a state where the application is unavailable. For example: according to a judgment result, when it is obtained that a function of an application is unavailable, the state where the application is available is changed into the state where the application is unavailable; or when the function of the application is changed from an unavailable state into an available state, the state where the application is unavailable is changed into the state where the application is available.

In some implementation manners, the application has multiple functions, condition information on which a certain function thereof relies changes, resulting in that the function is unavailable but other functions are still in an available state, and thus the state of availability of the application further includes: a state where the application is partially available.

In an embodiment of the subject application, each state of availability of the application corresponds to a display state. In a possible implementation manner of an embodiment of the subject application, the display state is displayed through a display icon corresponding to the application.

For example, colors of display icons corresponding to the application can be used to indicate different states of availability of the application: a colorful icon indicates that the application is available, and a gray icon indicates that the application is unavailable; or different states of availability of the application can be indicated by adding special symbols: that the display icon has no special symbols indicates that the application is available, that the display icon has a small triangle in the upper right corner indicates that the application is partially available, and that the display icon has a cross in the upper right corner indicates that the application is completely unavailable; or corresponding words are directly displayed around the display icon to indicate that.

In this way, when the function of the application is unavailable or partially available, the user can directly know that through the state of the display icon of the application, so it is unnecessary to click the display icon to run the corresponding application to find that the function of the application is unavailable, and then exit the application. In this way, on one hand, better use experience is brought about to the user, and on the other hand, it saves consumption of computing resources including electric energy brought about by the user's running the application and then exiting the application.

In a possible implementation manner of an embodiment of the subject application, the step of changing a state of the corresponding application includes: changing an operation state of the corresponding application.

The operation state of the application includes: a state where the application is active and a state where the application is inactive.

The state where the application is active includes a state where the application operates, and the state where the application is inactive includes a state where the application is closed. For example, if it is judged in step S120 that the function of a certain application is unavailable, the application is automatically closed in this step, so that the application is changed from an operation state into a closed state, to save computing resources such as electric energy.

In some possible implementation manners of an embodiment of the subject application, the application may be started for a longer time, and thus the operation state of the application further includes a state where the application is started. In the process that it is being started, a piece of condition information is acquired in step S110, and it is obtained through judgment in step S120 that the function of the application is unavailable, so the application is changed from the start state into a closed state, the state where the application is being started is cancelled, consumption of computing resource consumed by starting the application is reduced, and the user doesn't need to continuously wait for starting an unavailable application, which improves user experience.

In some possible implementation manners of an embodiment of the subject application, the operation state of the application may further include a dormant state of the application. When the application is in the operation state, after it is obtained that the function of the application is unavailable, the application can be automatically changed into a dormant state, so as to save computing resources such as electric energy.

In a possible implementation manner of an embodiment of the subject application, the step of changing a state of the corresponding application includes: changing a position of the corresponding application in a display list relevant to the condition information.

For example, a possible display list is a display list provided when a user wants to close applications, where some applications needing to be preferentially closed are displayed in the forefront of the display list. The display list, for example, may be relevant to the endurance capability of the system, and when the acquired condition information displays that the endurance capability of the system is insufficient, the applications with the maximum power consumption are displayed in the forefront of the display list; or the display list, for example, may be relevant to the location of the system and service geographical limit information, for example, when the acquired condition information includes that the current location is Wuxi, the display list displays the applications having the e-coupons that can be used in Wuxi in the forefront of the display list and the like.

The above embodiments of the subject application describe three methods of changing a state of a corresponding application, and one of the three methods can be selected to change the state of the application, or one or more thereof can be selected to change the state at the same time.

The embodiments of the subject application are further described below in a possible implementation manner, and the implementation manner includes:

acquiring context information of a current location of a system and positioning capability information of the system, where the system cannot obtain a good positioning signal according to the positioning capability and the current location of the system; the system has an application A whose function relies on the positioning capability of the system very much, and under the condition, the function of the application A cannot be used; the system further has an application B whose one function relies on the positioning capability of the system, and under the condition, some functions of the application B can be used; functions of other applications do not rely on the positioning capability of the system at all.

It is judged according to the above content that the state of availability of the function of the application A relying on the condition information is changed into an unavailable state; and the availability of the function of the application B relying on the condition information is reduced, but the function is still available.

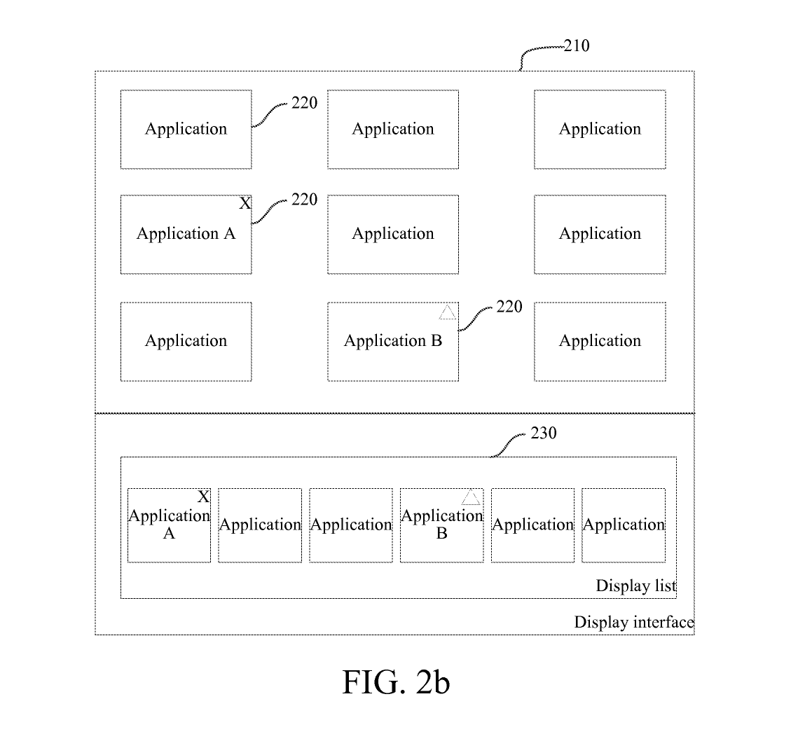

According to the judgment result, on one hand: as shown in FIG. 2a, the application A is changed from an available state into an unavailable state, and a cross is added to the upper right corner of a display icon 220 of the application A in a display interface 210; the application B is changed from an available state into a partially available state, and a triangle is added to the upper right corner of the display icon 220 of the application B; on the other hand: as shown in FIG. 2b, on a display list 230 of preferentially closed applications recommended by the system, the position of the application A is put in the forefront; the position of the application B is also correspondingly adjusted towards the front. It can be seen from FIG. 2a and FIG. 2b that, the state of availability of the applications and positions in the list can be displayed separately, or be cross-displayed at the same time.

Persons skilled in the art may understand that, in a method of the subject application, the serial number of each step does not mean the sequence of execution, and the sequence of execution of each step should be determined with its function and internal logic, but should not make any limitations to implementation of DETAILED DESCRIPTION OF THE EMBODIMENTS of the subject application.

It can be seen from the above description that, the application management method according to the embodiment of the subject application can reduce resources consumed by the application as the condition on which the function of the application relies cannot satisfy normal use of the application, reduce unnecessary user operations, and improve user experience.

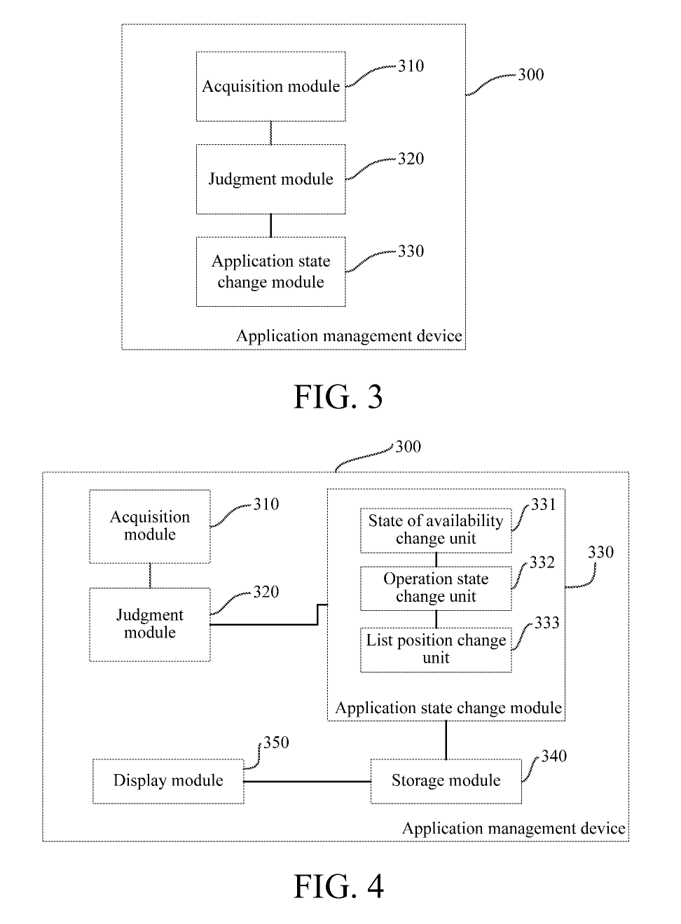

As shown in FIG. 3, an embodiment of the subject application further provides an application management device 300, including:

an acquisition module 310, for acquiring at least one piece of condition information, where at least one function of at least one application relies on the condition information;

a judgment module 320, for judging whether a change occurs to a state of availability of a function of an application relying on the condition information according to the condition information acquired by the acquisition module 310, and generating corresponding change information when the change occurs; and

an application state change module 330, for changing a state of the corresponding application according to the change information.

In a possible implementation manner of the embodiment of the subject application, the condition information includes context information relevant to a system where the application is located, and/or capability information relevant to a system where the application is located, and/or user usage mode information and/or service plan information.

The condition information is the same as that described in the above method embodiment, which is specifically as follows.

The context information relevant to a system where the application is located includes at least one of the following information: time, location, temperature, humidity, social environment, acceleration of the system and inclination of the system.

The capability information relevant to a system where the application is located includes at least one of the following information: positioning capability, data access capability, communication capability, direction indication capability, storage capability, operational capability, multimedia output capability, input capability and local data access capability.

The user usage mode information includes at least one of the following information: probability that a user uses the application and probability that the user uses the application in the case that a system relevant to the application is in a particular context and/or capability.

The service plan information includes at least one of the following information: service quota limit and currently used quota information, service time limit information and service geographical limit information.

As shown in FIG. 4, in a preferred implementation manner of the embodiment of the subject application, the device further includes a storage module 340, for storing parameter information of the application, where the parameter information of the application includes information about reliance of the application on the corresponding condition information.

The judgment module 320 is further used for judging whether a change occurs to a state of availability of a function of an application relying on the condition information according to the condition information acquired by the acquisition module 310 and the information about reliance of the application on the corresponding condition information stored by the storage module 340. The judgment method thereof is as disclosed in the above method embodiment.

In the embodiment of the subject application, the application state change module 330 includes: a state of availability change unit 331, and/or an operation state change unit 332 and/or a list position change unit. The units implement their functions according to corresponding description in the above method embodiment, which are specifically as follows.

The state of availability change unit 331 is used for changing a state of availability of the corresponding application according to the change information.

The operation state change unit 332 is used for changing an operation state of the corresponding application according to the change information.

The list position change unit 333 is used for changing a position of the corresponding application in a display list relevant to the condition information according to the change information.

Each state of availability of the application can correspond to a display state.

The device can further include a display module 350, which implements its function according to corresponding description in the above method embodiment, and may be as follows: for displaying the display state through a display icon corresponding to the application.

In a possible implementation manner of the embodiment of the subject application, the application management device can be a mobile terminal. The mobile terminal, for example, may be: a smart phone, a tablet computer, a notebook computer, a vehicle-mounted computer or the like.

In addition, an embodiment of the subject application further provides a computer readable medium, including a computer readable instruction performing the following operations when being executed: executing operations in steps S110, S120 and S130 of the method in the embodiment shown in FIG. 1.

It can be seen from the above description that, the application management device according to the embodiment of the subject application can reduce resources consumed by the application as the condition on which the function of the application relies cannot satisfy normal use of the application, reduce unnecessary user operations, and improve user experience.

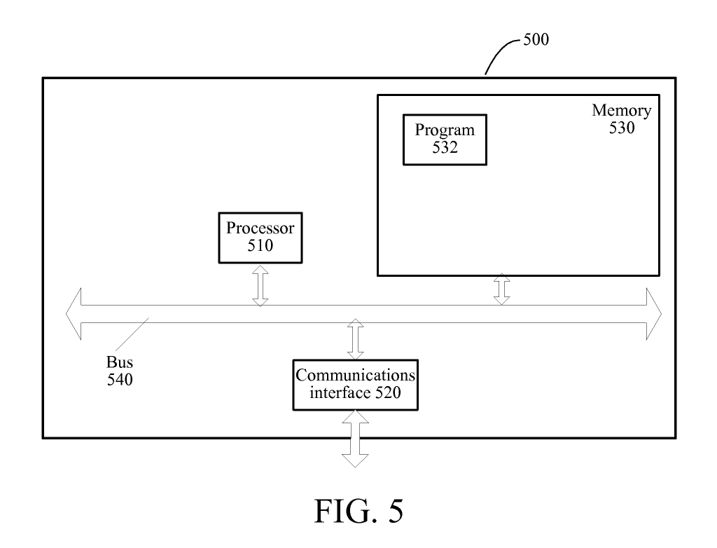

FIG. 5 is a schematic structural view of a further application management device 500 according to an embodiment of the subject application, and the specific embodiment of the subject application does not limit the specific implementation of the application management device 500. As shown in FIG. 5, the application management device 500 may include:

a processor 510, a communications interface 520, a memory 530 and a communications bus 540.

The processor 510, the communications interface 520 and the memory 530 complete mutual communications through the communications bus 540.

The communications interface 520 is used for communicating with, for example, a network element such as a server.

The processor 510 is used for executing a program 532, and specifically can execute relevant steps in the method embodiment shown in FIG. 1 or FIG. 2.

Specifically, the program 532 may include a program code, and the program code includes a computer operating instruction.

The processor 510 may be a CPU, or an Application Specific Integrated Circuit (ASIC), or is configured as one or more integrated circuits implementing the embodiment of the present invention

The memory 530 is used for storing the program 532. The memory 530 may include a high-speed Random Access Memory (RAM), and also may include a non-volatile memory, for example, at least one magnetic disk memory. The program 532 specifically may make the device 500 execute the following steps:

acquiring at least one piece of condition information, where at least one function of at least one application relies on the condition information;

judging whether a change occurs to a state of availability of a function of an application relying on the condition information according to the condition information acquired by the acquisition module, and generating corresponding change information when the change occurs; and

changing a state of the corresponding application according to the change information.

Reference can be made to corresponding description about the corresponding step or unit in the above embodiment for specific implementation of each step in the program 532, which is not repeated herein. Persons skilled in the art can clearly understand that, for purpose of convenient and concise description, for the specific operating process of the above device and modules, reference can be made to the description about the corresponding process in the above method embodiment, which is not repeated herein.

Persons of ordinary skill in the art can realize that, the units and the steps of the method in the examples described in combination with the embodiments disclosed herein can be implemented with electronic hardware, or a combination of computer software and electronic hardware. Whether the functions are executed by hardware or software depends upon particular applications and design constraints of a technical solution. Persons skilled in the art can use a different method for each particular application to achieve the described functions, but such implementation should not be considered beyond the scope of the subject application.

If the functions are implemented in the form of software function units and are sold or used as individual products, they can be stored in a computer readable storage medium. Based on this understanding, a technical solution of the subject application or the part that makes contributions to the prior art or part of a technical solution can be substantially embodied in the form of a software product. The computer software product may be stored in a storage medium, and contain several instructions to instruct a computer device (for example, a personal computer, a server, or a network device) to perform all or part of the steps of the method as described in the embodiments of the subject application. The storage medium includes any medium that can store program codes such as a USB flash disk, a removable hard disk, a Read-Only Memory (ROM), a RAM, a magnetic disk or an optical disc.

The above implementation manners are only provided for describing the subject application, but not intended to limit the subject application. Persons of ordinary skill in the art can make various variations and modifications without departing from the spirit and scope of the subject application, and thus all equivalent technical solutions fall into the category of the subject application, and the patent protection scope of the subject application should be defined by the claims.

1. A method, comprising:
acquiring, by a device comprising a processor, at least one piece of condition information, wherein at least one function of at least one application is based on the at least one piece of condition information; and
determining whether a change occurs to at least one state of availability of the at least one function of the at least one application according to the at least one piece of condition information:
in response to the change being determined to have occurred, changing the at least one state of availability of the at least one function of the at least one application according to the change.

2. The method of claim 1, wherein the at least one piece of condition information comprises context information relevant to a system where the at least one application is located.

3. The method of claim 2, wherein the context information relevant to the system where the at least one application is located comprises at least one of a time of the system, a location of the system, a temperature of the system, a humidity of the system, a social environment of the system, an acceleration of the system or an inclination of the system.

4. The method of claim 1, wherein the at least one piece of condition information comprises capability information relevant to a system where the at least one application is located.

5. The method of claim 4, wherein the capability information relevant to the system where the at least one application is located comprises at least one of a positioning capability of the system, a data access capability of the system, a communication capability of the system, a direction indication capability of the system, a storage capability of the system, an operational capability of the system, a multimedia output capability of the system, an input capability of the system or a local data access capability of the system.

6. The method of claim 1, wherein the at least one piece of condition information comprises user usage mode information.

7. The method of claim 6, wherein the user usage mode information comprises at least one of a first probability that a user identity uses the at least one application and a second probability that the user identity uses the at least one application in a case that a system relevant to the at least one application is at least one of in a defined context or has a defined capability.

8. The method of claim 1, wherein the at least one piece of condition information comprises service plan information.

9. The method of claim 8, wherein the service plan information comprises at least one of a service quota limit, currently used quota information, service time limit information or service geographical limit information.

10. The method of claim 1, wherein the at least one application comprises parameter information, and the parameter information of the at least one application comprises information about at least one reliance of the at least one application on corresponding pieces of the at least one piece of condition information.

11. The method of claim 10, wherein the determining whether the change occurs to the at least one state of availability of the at least one function of the at least one application comprises:
determining whether the change occurs to the at least one state of availability of the at least one function of the at least one application relying on the at least one piece of condition information and the information about the at least one reliance of the at least one application on the corresponding pieces of the at least one piece of condition information.

12. The method of claim 1, wherein the changing the at least one state of availability of the at least one function of the at least one application according to the change comprises:
changing the at least one state of availability of the at least one application from a first state of availability to a second state of availability different from the first state.

13. The method of claim 12, wherein the at least one state of availability of the at least one function of the at least one application comprises: the first state where the at least one application is available and the second state where the at least one application is unavailable.

14. The method of claim 13, wherein the at least one state of availability of the at least one function of the at least one application further comprises: the first state or the second state where the application is partially available.

15. The method of claim 12, wherein each of the at least one state of availability of the at least one function of the at least one application corresponds to a display state.

16. The method of claim 15, wherein the display state of each is displayed via at least one display icon corresponding to the at least one application.

17. The method of claim 1, wherein the changing the at least one state of availability of the at least one function of the at least one application according to the change comprises:
changing at least one operation state of the at least one application.

18. The method of claim 17, wherein the at least one operation state of the at least one application comprises: a first state where the at least one application is active and a second state where the at least one application is inactive.

19. The method of claim 18, wherein the first state where the at least one application is active comprises: an operational state where the at least one application operates.

20. The method of claim 18, wherein the first state where the at least one application is active comprises: a starting state where the at least one application is being started.

21. The method of claim 18, wherein the second state where the at least one application is inactive comprises: a closing state where the at least one application is closed.

22. The method of claim 18, wherein the second state where the at least one application is inactive comprises: a dormant state where the at least one application is dormant.

23. The method of claim 1, wherein the changing a the at least one state of availability of the at least one function of the at least one application according to the change comprises:
changing at least one position of the at least one application in a display list relevant to the at least one piece of condition information.

24. A device, comprising:
a processor, coupled to a memory, that executes or facilitates execution of executable modules, the executable modules comprising:
an acquisition module configured to acquire condition information, wherein at least one function of at least one application relies on the condition information;
a judgment module configured to determine whether a change occurs to at least one state of availability of the at least one function of the at least one application according to the condition information acquired by the acquisition module, and generate change information when the change is determined to have occured; and
an application state change module configured to change the at least one state of availability of the at least one function of the at least one application according to the change information.

25. The device of claim 24, wherein the executable modules further comprise a storage module configured to store parameter information of the at least one application, and the parameter information comprises information about at least one reliance of the at least one application on the condition information.

26. The device of claim 25, wherein the judgment module is further configured to determine whether the change occurs according to the condition information and the information about the at least one reliance of the at least one application.

27. The device of claim 24, wherein the application state change module comprises:
a state of availability change unit configured to change the at least one state of availability of the at least one function of the at least one application according to the change information.

28. The device of claim 27, wherein each of the at least one state of availability of the at least one function of the at least one application corresponds to a respective display state.

29. The device of claim 28, wherein the executable modules further comprise a display module configured to display the respective display state for each via at least one display icon corresponding to the at least one function of the at least one application.

30. The device of claim 24, wherein the application state change module comprises:
an operation state change unit configured to change at least one operation state of the at least one application according to the change information.

31. The device of claim 24, wherein the application state change module comprises:
a list position change unit configured to change at least one position of the at least one application in a display list relevant to the condition information according to the change information.

32. The device of claim 24, wherein the device is a mobile terminal.

33. (canceled)

34. A computer readable storage device comprising executable instructions that, in response to execution, cause a device comprising a processor to perform operations, comprising:
receiving condition information, wherein a function of an application is based on the condition information; and
determining whether a change has occured to a state of availability of the function of the application according to the condition information:
in response to the change being determined to have occurred, changing the state of availability of the function of the application according to the change.

35. An application management device, wherein the application management device comprises a processor, a memory and a communications interface,
the memory stores a computer operating instruction, the processor, the memory and the communications interface are connected through a communications bus, and
when the application management device operates, the processor executes the computer operating instruction stored by the memory, so that the application management device executes operations comprising:
acquiring condition information, wherein a function of at least one application is based on the condition information;
determining whether a change has occured to a state of availability of the function of the at least one application according to the condition information: and
in response to the change being determined to have occurred, changing the state of availability of the function of the at least one application according to the change.
